(19) United States
(12) Patent Application Publication
(10) Pub. No.: US 2011/0118918 A1
(43) Pub. Date: May 19, 2011

(54) ADAPTATION OF A STEADY-STATE MAXIMUM TORQUE OF AN INTERNAL COMBUSTION ENGINE

(76) Inventors: Jens-Werner Falkenstein, Aalen (DE); Martin Lang, Hausleiten (AT)

(21) Appl. No.: 12/736,447

(22) PCT Filed: Mar. 19, 2009
(86) PCT No.: PCT/EP2009/053268

§ 371 Date: Jan. 13, 2011

(30) Foreign Application Priority Data
Apr. 11, 2008 (DE) 10 2008 001 128.2

(51) Int. Cl. B60W 20/00; F02D 45/00; F02D 41/30

(52) U.S. Cl. 701/22; 701/102; 701/104; 180/65.28; 903/902

(57) ABSTRACT

In a method for operating an internal combustion engine, a steady-state maximum output torque and a dynamic maximum torque are ascertained. The ascertained steady-state maximum output torque is changed to a resulting steady-state maximum torque by adapting the maximum output torque in such a way that it is equal to or greater than the ascertained dynamic maximum torque.

### BACKGROUND OF THE INVENTION

1. Field of the Invention

The present invention relates to a method and a device for operating an internal combustion engine for which a steady-state maximum torque and a dynamic maximum torque are ascertained.

2. Description of Related Art

Ascertainment of a steady-state maximum torque and a dynamic maximum torque for an internal combustion engine is known. The steady-state maximum torque is primarily a function of an instantaneous rotational speed of the internal combustion engine, and of the maximum possible charge of air or air fuel mixture in the combustion chambers of an internal combustion engine at this rotational speed. Since the maximum charge is not reached in many operating states of the internal combustion engine, and must be built up only when needed, a generated actual torque up to the steady-state maximum torque may be increased only with a delay, which is a function in particular of the air path dynamics of an air or mixture delivery and/or the turbocharger dynamics of a turbocharger. This delay is in a range of 200 to 500 milliseconds. Modern spark ignition engines usually have an electronic throttle valve for regulating the air mass flow for the internal combustion engine. The electronic throttle valve is mechanically decoupled from a gas pedal. Since an appropriate throttle valve actuator has a finite adjustment speed, and dynamic charge effects are present as the result of air path dynamics in the intake manifold, a highly dynamic adjustment of a specified air mass flow and of the instantaneous charge thus generated is not possible. The dynamic maximum torque is primarily a function of the instantaneous rotational speed and the instantaneous charge. The generated actual torque may be increased up to the dynamic maximum torque essentially without delay. For a spark ignition engine, the dynamic maximum torque may be reached in homogenous operation by changing an ignition angle. For a diesel engine or spark ignition engine in inhomogeneous operation, the dynamic maximum torque may be achieved by adjusting an injection quantity. This adjustment is usually possible from one ignition to the next, which means a time delay of approximately 30 milliseconds. Intervention into the ignition angle changes the efficiency of the spark ignition engine and has an effect on the actual torque. If the ignition angle is decreased, resulting in “early” ignition, the actual torque of the internal combustion engine is increased. The spark ignition engine delivers its dynamic maximum torque at the smallest possible ignition angle. The ignition angle may be changed again for each individual ignition, thus allowing the dynamic maximum torque to be adjusted essentially without delay.

For a diesel engine, a change in the injection quantity may change the generated actual torque essentially without delay, although the maximum injection quantity is limited by the “smoke limit,” and therefore by the instantaneous charge. Thus, a dynamic maximum torque is likewise present for diesel engines which is a function of the instantaneous charge, and which may be adjusted by changing the injection quantity from one injection to the next, and therefore essentially without delay. For turbo systems, which are widely used in modern diesel engines, change dynamics of the instantaneous charge are likewise limited by the dynamics of the turbo system.

When the internal combustion engine is driven at maximum charge, the dynamic maximum torque corresponds to the steady-state maximum torque. In all other operating states the dynamic maximum torque is less than the steady-state maximum torque, since the instantaneous charge is less than the maximum charge.

For controlling a hybrid vehicle, power, i.e., setpoint torques, must be distributed over multiple drive units, in particular an internal combustion engine and one or multiple electric machines. For this purpose it is necessary to have information concerning the possible operating ranges and the maximum generatable torques of the drive units. A distinction between the dynamic maximum torque and the steady-state maximum torque in the internal combustion engine is important in order to optimally coordinate the assistance of the internal combustion engine by one or multiple electric machines. This is illustrated using two operating states as an example. In the first operating state the electric machine is intended to provide only short-term assistance to the internal combustion engine until the dynamic maximum torque of the internal combustion engine, which is too low at that moment, has been raised by increasing the instantaneous charge. Thus, due to the air path dynamics the dynamic maximum torque is temporarily insufficient to meet a torque request. The steady-state maximum torque, on the other hand, is sufficient. Such assistance is referred to as “transient compensation.” In the second case the electric machine is intended to provide more long-term assistance to the internal combustion engine, since the internal combustion engine is already being operated at maximum charge, as a result of which the dynamic maximum torque corresponds to the steady-state maximum torque and is not capable of a further increase. Such assistance is referred to as “boost.” Each operating state requires a different strategy for coordinating the various drive units, and requires appropriate limiting mechanisms which terminate assistance of the internal combustion engine by the electric machine. This may be the case, for example, when the energy content of an electrical storage medium for the electric machine drops below a specified value. In order for the control system to be able to differentiate between and coordinate the operating modes, i.e., to carry out the limiting mechanisms, the steady-state maximum torque and the dynamic maximum torque are ascertained and made available to the control system. To allow the steady-state maximum torque to be ascertained, the maximum charge must be determined, which is possible only by estimation when the internal combustion engine is not operated at maximum charge at that moment. This results in inaccuracies, since it is not possible for the entire complexity of the air path dynamics to be reflected in the estimation. The physical input variables which are necessary for this purpose are not measurable for cost reasons, or are not precisely ascertainable due to inaccuracies of the sensors. The ascertained steady-state maximum torque may thus contain inaccuracies. If the internal combustion engine is operated at full load, in which instantaneous charge corresponds to the maximum charge, the ascertained steady-state maximum torque may differ from the ascertained dynamic maximum torque as a result of the inaccuracies. The control, in particular of a hybrid vehicle, which makes use of the steady-state maximum torque and the dynamic maximum torque as input variables, therefore sometimes contains implausible and contradictory information, which prevents optimal control.

### BRIEF SUMMARY OF THE INVENTION

Based on the method according to the present invention, it is provided that the ascertained steady-state maximum torque is a steady-state output maximum torque which is changed to a resulting steady-state maximum torque by adapting the latter in such a way that it is equal to or greater than the ascertained dynamic maximum torque. To allow optimal control of the internal combustion engine to be achieved, the steady-state maximum torque must always be equal to or greater than the dynamic maximum torque, since information that the steady-state maximum torque is less than the dynamic maximum torque is implausible, and may not be correctly evaluated for operating the internal combustion engine. In addition, when the internal combustion engine is operated at maximum charge the steady-state and the dynamic maximum torques must be equal. For this reason the instantaneously ascertained steady-state maximum torque is adapted to the ascertained dynamic maximum torque by first regarding the latter as steady-state maximum output torque and comparing it to the instantaneously ascertained dynamic maximum torque. If one of the two conditions is not met, the steady-state maximum output torque is changed to a resulting steady-state maximum torque which fully, or at least better, meets the conditions. The resulting steady-state maximum torque may then be plausibly evaluated for operating the internal combustion engine.

According to one refinement of the present invention, it is provided that the steady-state maximum torque and/or dynamic maximum torque is/are ascertained using a model based on at least one variable and/or at least one characteristic curve. As previously described for the related art, since the necessary variables for determining the maximum charge are not measured for economic reasons, or are not exactly ascertainable due to inaccuracies of the sensors, the steady-state maximum torque is computed using the model, which is a computation model. The computation model contains a simplified relationship for ascertaining the maximum charge, which may then be determined as a function of detected variables. Alternatively, the maximum charge or the steady-state maximum torque is ascertained with the aid of a characteristic curve, which contains values that have been ascertained through testing, for example on engine test benches. The dynamic maximum torque may also be computed using an appropriate model, which likewise is a computation model. This computation model contains a simplified relationship for ascertaining the instantaneous charge, which may then be determined as a function of detected variables. Alternatively, determining the instantaneous charge using a characteristic curve is also possible for the dynamic maximum torque.

According to one refinement of the present invention, it is provided that for ascertaining the steady-state maximum torque, the rotational speed of the internal combustion engine, a charge, in particular a maximum charge, in at least one combustion chamber of the internal combustion engine, an ignition angle, in particular the smallest possible ignition angle, of an ignition device of the internal combustion engine, a fuel quantity, an injection quantity, in particular a maximum possible injection quantity, a fuel distribution in the combustion chamber, a fuel quality, and/or an air/fuel ratio is/are used as variables. In ascertaining the steady-state maximum torque, in particular the principle of the internal combustion engine must be taken into account, since this principle limits the available variables. For a diesel engine, for example, the charge is composed only of air, and there is no ignition angle. For a spark ignition engine, on the other hand, the charge is composed of an air fuel mixture which is introduced into the internal combustion engine or is generated in the combustion chamber using an injector, resulting in a different charge behavior. In addition, the generation of the steady-state maximum torque may be computed as a function of the fuel distribution in the combustion chamber, which may be changed only by design measures, the fuel quality, which influences the intensity of combustion, and the air/fuel ratio, which describes the composition of the air and fuel mixture. The additional use of these variables results in improved accuracy of the ascertainment. According to one refinement of the present invention, it is provided that for ascertaining the dynamic maximum torque the rotational speed of the internal combustion engine, the charge, in particular the instantaneous charge, in the combustion chamber of the internal combustion engine, the ignition angle, in particular the smallest possible ignition angle, of the ignition device of the internal combustion engine, the fuel quantity, the injection quantity, in particular the maximum possible injection quantity, the fuel distribution in the combustion chamber, the fuel quality, and/or the air/fuel ratio is/are used as variables. The difference between ascertaining the dynamic maximum torque and ascertaining the steady-state maximum torque is that the dynamic maximum torque is ascertained based on the instantaneous charge in the combustion chamber. For this purpose, the instantaneous charge may preferably be ascertained on the basis of measured variables such as the air mass implemented in the internal combustion engine, a rotational speed of the internal combustion engine, an intake manifold pressure and/or charge pressure, an intake air temperature, an ambient air pressure, a throttle valve position, an exhaust gas recirculation rate, a position of at least one camshaft, a position of at least one valve in the intake duct, the rotational speed, the fuel quality, and/or the air/fuel ratio. Accuracy of the ascertainment of the dynamic maximum torque is a function in particular of the accuracies of the supplied variables and the accuracy of the ascertained instantaneous charge, which in particular are a function of measuring accuracies of sensors used for detecting appropriate signals.

According to one refinement of the present invention, it is provided that a characteristic curve is used, the characteristic curve describing the steady-state and/or dynamic maximum torque based on at least one variable, in particular the rotational speed of the internal combustion engine. Rotational speeds are frequently ascertained in motor vehicles. In conjunction with the characteristic curve, rotational speeds represent an easily implemented option, in particular for ascertaining a steady-state maximum output torque and/or a dynamic maximum torque.

According to one refinement of the present invention, it is provided that for the adaptation at least one correction term is applied to the steady-state maximum output torque to obtain the resulting steady-state maximum torque. The correction term may be a scalar, a vector, or a function, for example. The vector is preferably generated by one or multiple measured or computed variables. Higher accuracy is thus achieved for the resulting steady-state maximum torque than for the steady-state maximum output torque, and a correlation between the resulting steady-state maximum torque and the dynamic maximum torque is achieved when the internal combustion engine is operated at maximum charge. The steady-state maximum torque may also be adapted when limiting of the dynamic maximum, for example as the result of component protective mechanisms, is present.

According to one refinement of the method, it is provided that the correction term is changed by a correction term adaptation in such a way that the resulting steady-state maximum torque approaches the dynamic maximum torque and converges to the value of same. To bring the correction term to the correct value, it is provided that the correction term is adapted using the correction term adaptation. This adaptation is checked by taking into account the behavior of the resulting steady-state maximum torque with respect to the dynamic maximum torque, the dynamic maximum torque functioning as a reference. The correction term may be changed by applying a correction term adaptation scalar, a correction term adaptation vector, and/or a correction term function which is/are generated by one or multiple measured or computed variables.

According to one refinement of the present invention, it is provided that the correction term adaptation is carried out when operation of the internal combustion engine at maximum charge in the combustion chamber is detected. When the internal combustion engine is operated at maximum charge, the condition applies that the dynamic maximum torque and the resulting steady-state maximum torque must be equal. When the correction term adaptation recognizes that the internal combustion engine is operated at maximum charge, the correction term is adapted in such a way that the dynamic maximum torque and the resulting steady-state maximum torque are equal.

According to one refinement of the present invention, it is provided that the operation of the internal combustion engine at maximum charge is detected via the position of a throttle valve of the internal combustion engine. The air mass flow into the internal combustion engine may be deduced from the position of the throttle valve. When the throttle valve is almost or completely open, the maximum charge results due to the high air mass flow. In addition, the intake manifold pressure, the charge pressure of a turbo system, and/or a limitation of the charge pressure may be used as an indicator for operation of the internal combustion engine at maximum charge. Also valid as such an indicator is a time period over which high energy, for example as the result of large injection quantities, is present in the exhaust gas, since afterward a further increase in the charge pressure of a turbo system, and thus an increase in the charge, is not expected.

According to one refinement of the present invention, it is provided that a delay time is awaited for reliably detecting the operation of the internal combustion engine at maximum charge. If a maximum charge is expected after detecting an appropriate indicator, it is advantageous to wait during a delay time until the maximum charge has completely formed and actually developed its effect before the adaptation is carried out.

According to one refinement of the present invention, it is provided that the correction term is adapted when the resulting steady-state maximum torque is less than the ascertained dynamic maximum torque. Since this state does not meet the necessary conditions, this involves a measuring or detection error which may be compensated for by increasing the resulting steady-state maximum torque until the resulting steady-state maximum torque is equal to the dynamic maximum torque. A correction term adaptation may also be carried out when this failure to meet the condition is to be expected.

According to one refinement of the present invention, it is provided that the method according to the present invention is used for a hybrid drive device. When plausible and noncontradictory steady-state maximum torque and dynamic maximum torque are present, the coordination of vehicle control, in particular the control of a hybrid vehicle, may be optimized, since the total torque request may be optimally distributed according to the individual drive units.

In addition, an internal combustion engine is provided which is used in particular for carrying out the above-described method, for which a value of a steady-state maximum torque and a value of a dynamic maximum torque are ascertained. This internal combustion engine has an adaptation device which changes the ascertained steady-state maximum torque, which is a steady-state maximum output torque, to a resulting steady-state maximum torque in such a way that the latter is equal to or greater than the ascertained dynamic maximum torque.

Furthermore, a hybrid drive device of a motor vehicle is provided which is used in particular for carrying out the above-described method and which has at least two different drive units, an internal combustion engine and in particular an electric machine, a steady-state maximum torque and a dynamic maximum torque being ascertained for the internal combustion engine. It is provided that the hybrid drive device has an adaptation device which changes the ascertained steady-state maximum torque, which is a steady-state maximum output torque, to a resulting steady-state maximum torque in such a way that the latter is equal to or greater than the ascertained dynamic maximum torque.

### BRIEF DESCRIPTION OF THE DRAWINGS

FIG. 1 shows one exemplary embodiment of the method according to the present invention.

FIG. 2 shows simulation results of the exemplary embodiment from FIG. 1.

FIG. 3 shows simulation results of the exemplary embodiment from FIG. 1.

### DETAILED DESCRIPTION OF THE INVENTION

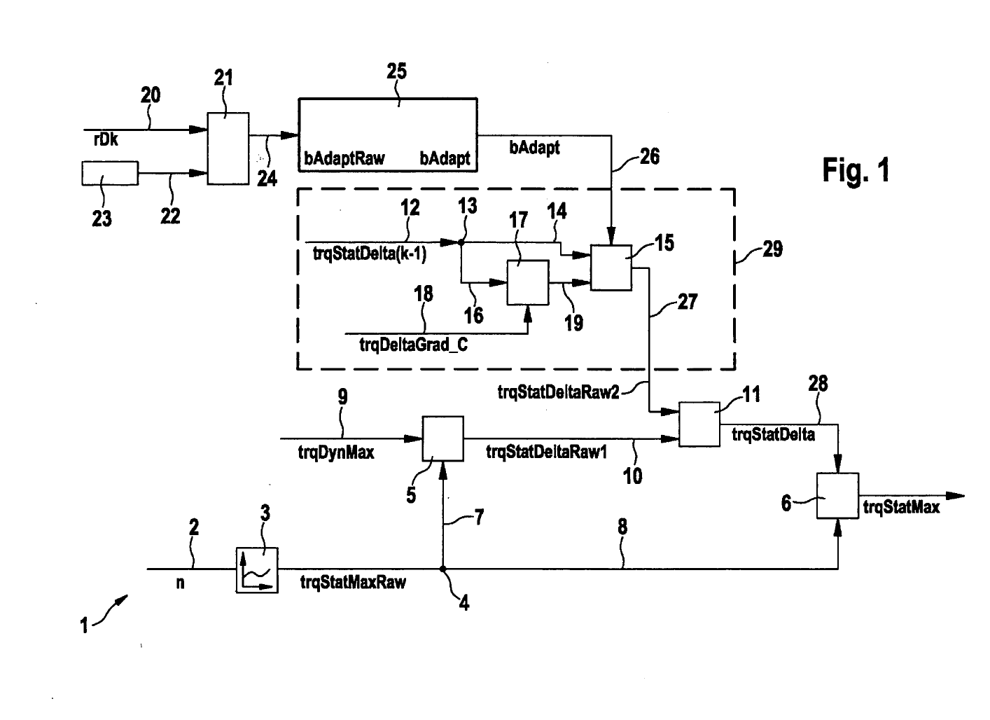

FIG. 1 shows one exemplary embodiment of the method according to the present invention for adapting a steady-state maximum torque. The exemplary embodiment concerns an aspirated spark ignition engine (not illustrated) having an electronic throttle valve, and is composed of a computation program 1 which is cyclically operated in individual sampling steps as a sampling system. In a sampling step k having a period duration T, computed values are stored and used in a subsequent sampling step k+1. This allows the values which are computed in a preceding sampling step (k−1) and then stored to be used for computing valid values for instantaneous sampling step k. Computation program 1 receives via an arrow 2 a rotational speed n, which is supplied to a characteristic curve 3. Characteristic curve 3 ascertains a steady-state maximum torque trqStatMaxRaw, which is relayed to a node 4. Starting from node 4, steady-state maximum torque trqStatMaxRaw is relayed on the one hand to a subtracter 5 and on the other hand to an adder 6 via arrows 7 and 8, respectively. Subtracter 5 is supplied via an arrow 9 with an ascertained dynamic maximum torque trqDynMax, from which steady-state maximum torque trqStatMaxRaw, the steady-state maximum output torque, is subtracted in subtracter 5. A first precorrection value trqStatDeltaRaw1 results in subtracter 5, and is relayed via an arrow 10 to a maximizer 11. A correction term trqStatDelta (k−1) for preceding sampling step (k−1) is also supplied via an arrow 12 to computation program 1. Arrow 12 leads to a node 13, from which an arrow 14 leads to a switching block 15, and an arrow 16 leads to a subtracter 17. A correction adaptation term trqDeltaGrad_C is also supplied to subtracter 17 via an arrow 18. Subtracter 17 subtracts correction adaptation term trqDeltaGrad_C from correction value trqStatDelta (k−1), and relays the result to switching block 15 via an arrow 19. A relative throttle valve position rDk is relayed via an arrow 20 to a comparator block 21, which also receives a constant 23 via an arrow 22. Comparator block 21 relays a binary adaptation presignal bAdaptRaw to a time delay unit 25 via an arrow 24. Time delay unit 25 delays binary adaptation presignal bAdaptRaw and thus generates a binary adaptation signal bAdapt, which is relayed to switching block 15 via an arrow 26. Switching block 15 is switched as a function of binary adaptation signal bAdapt, and supplies a corresponding second precorrection value trqStatDeltaRaw2 to maximizer 11 via an arrow 27. Maximizer 11 selects the precorrection value which is the larger of the two precorrection values trqStatDeltaRaw1 and trqStatDeltaRaw2, and relays same as correction value trqStatDelta to adder 6 via an arrow 28. Correction value trqStatDelta is added to steady-state maximum torque trqStatMaxRaw in adder 6, resulting in a steady-state maximum torque trqStatMax. Computation program 1 for ascertaining resulting steady-state maximum torque trqStatMax is thus composed of a characteristic curve 3, which on the basis of instantaneous rotational speed n of the spark ignition engine ascertains steady-state maximum torque trqStatMaxRaw and adds same to a correction value trqStatDelta. The data input for characteristic curve 3 has been ascertained beforehand on a test bench. First precorrection value trqStatDeltaRaw1 for correction value trqStatDelta is computed from dynamic maximum torque trqDynMax, which has been determined on the basis of measuring signals, for example, outside computation program 1. A second precorrection value trqStatDeltaRaw2 is computed in a correction term adaptation 29 for point in time k. First, relative throttle valve position rDk is compared to constant 23 in comparator block 21. If rDk is greater than constant 23, binary adaptation presignal bAdaptRaw=true is set and is delayed in block 25 for a specified time period. Adaptation signal bAdapt generated by time delay unit 25 controls correction term adaptation 29, it being assumed that for a change of the binary adaptation signal to bAdapt=true the instantaneous charge of the internal combustion engine corresponds to the maximum charge. Correction term adaptation 29 then changes correction value trqStatDelta by computing same in instantaneous sampling step k from valid correction value trqStatDelta (k−1) computed in preceding sampling step k−1. If the binary adaptation signal specifies that the instantaneous charge corresponds to the maximum charge when bAdapt=true, trqStatDeltaRaw2(k) is the valid precorrection value at point in time k:

trqStatDeltaRaw2(k)=trqStatDelta(k−1)−trqDeltaGrad_{—}C.

Valid correction value trqStatDelta (k−1) is decremented by correction adaptation term trqDeltaGrad_C in preceding sampling step (k−1). Following the formation of second precorrection value trqStatDeltaRaw2, first precorrection value trqStatDeltaRaw1 and second precorrection value trqStatDeltaRaw2 are compared in maximizer 11, and the larger value is relayed as correction value trqStatDelta to adder 6, where it is added to steady-state maximum torque trqStatMaxRaw, resulting in resulting steady-state maximum torque trqStatMax. In the illustrated exemplary embodiment, a value of 0.5 Nm is specified for correction adaptation term trqDeltaGrad_C. For a sampling period T of 10 ms this results in a decrease in correction value trqStatDelta, having a gradient of −50 Nm/s. Along this gradient, correction value trqStatDelta approaches first precorrection value trqStatDeltaRaw1. Due to maximizer 11, correction value trqStatDelta may not be less than first precorrection value trqStatDeltaRaw1. Thus, when correction term adaptation is active, resulting steady-state maximum torque trqStatMax varies in the opposite direction with respect to dynamic maximum torque trqDynMax. Resulting steady-state maximum torque trqStatMax is thus prevented from being less than dynamic maximum torque trqDynMax. Thus, for correction value trqStatDelta(k) the following expression applies in maximizer 11 for point in time k:

trqStatDelta(k)=MAX[trqStatDelta(k−1)−trqDeltaGrad_{—}C, trqStatDeltaRaw1(k)].

When correction term adaptation 29 is not active and bAdapt=false, the following expression is valid in maximizer 11:

trqStatDelta(k)=MAX[trqStatDelta(k−1), trqStatDeltaRaw1(k)].

Correction value trqStatDelta thus remains at its former value, or follows the first precorrection value. Thus, resulting steady-state maximum torque trqStatMax may not be less than dynamic maximum torque trqDynMax. As a result of constantly maintaining correction value trqStatDelta, the results of sampling steps k when correction term adaptation 29 is active also have an effect on sampling steps k when correction term adaptation 29 is not active. When correction term adaptation 29 repeatedly becomes active, a favorable starting value is already present, which in the ideal case requires only slight correction.

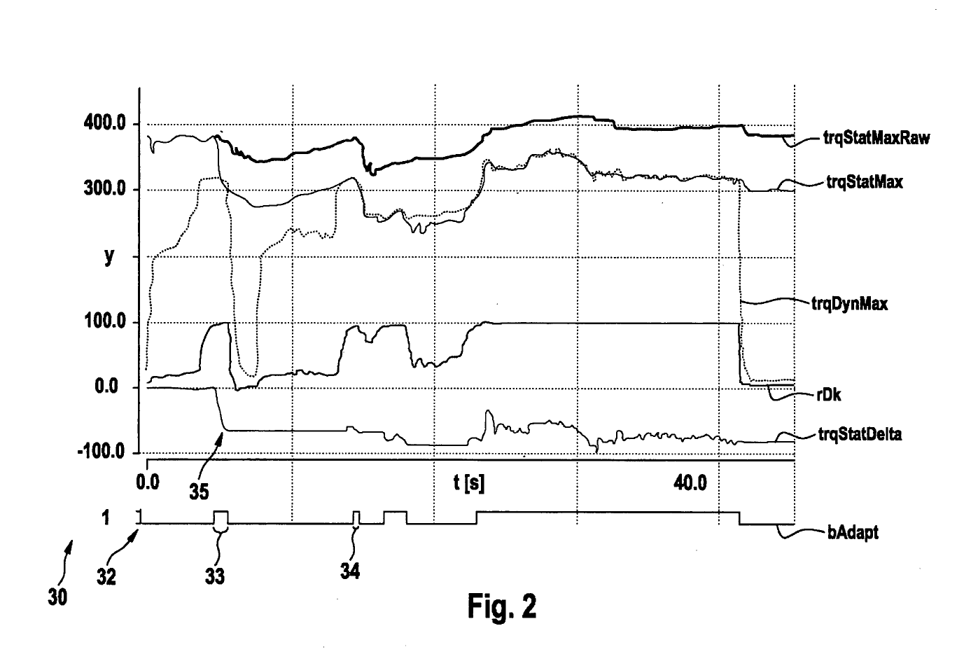

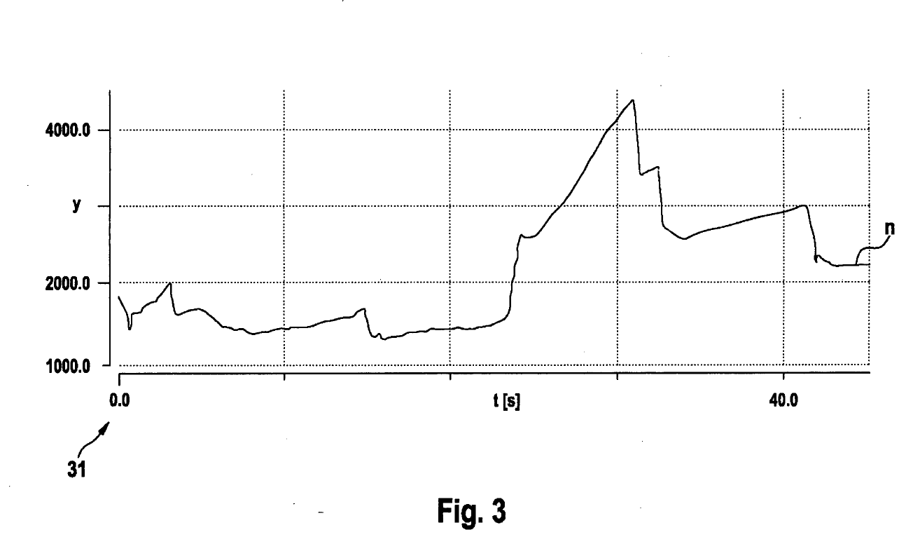

FIGS. 2 and 3 show measuring results for the exemplary embodiment from FIG. 1. FIG. 2 shows the variation over time of the signals of correction value trqStatDelta, throttle valve position rDk, dynamic maximum torque trqDynMax, steady-state maximum torque trqStatMaxRaw, and resulting steady-state maximum torque trqStatMax in a Cartesian coordinate system 30. In addition, a further coordinate system 32 is illustrated beneath Cartesian coordinate system 30 which shows the variation over time of binary signal bAdapt. Rotational speed n of an internal combustion engine is illustrated in Cartesian coordinate system 31 of FIG. 3. The input variables throttle valve position rDk, dynamic maximum torque trqDynMax, and instantaneous rotational speed n have been ascertained in an actual vehicle. At the start of the measurement, correction value trqStatDelta has been initialized to 0 Nm, but in a first correction term adaptation phase 33 has already quickly reached an optimal value 35. As a result of value 35 being kept constant after adaptation phase 33, a favorable starting value is already present for subsequent second correction term adaptation phase 34, so that correction value trqStatDelta is only slightly changed during second correction term adaptation phase 34. The data input for characteristic curve 3 from FIG. 1 and resulting steady-state maximum torque trqStatMaxRaw have been selected in such a way that in particular the effect of the method according to the present invention may be well represented. Correction value trqStatDelta is adapted, since the dependency on the rotational speed is not optimally detected using characteristic curve 3.

In an alternative aspect of the present invention, the exemplary embodiment may be improved by using a correction vector instead of a scalar correction value trqStatDelta. The individual vector elements of the correction vector are associated with individual data points of the measured or computed input variables. The correction vector may be generated, for example, by instantaneous rotational speed n, rotational speed data points existing for 1000 rpm, 2000 rpm, . . . , 6000 rpm, each of which is associated with a vector element. A correction value trqStatDelta which is associated with instantaneous rotational speed n is then computed from the associated vector elements of the two closest rotational speed data points via a linear interpolation. A change in correction value trqStatDelta, which is associated with instantaneous rotational speed n, is distributed on a weighted basis over the vector elements of the two closest rotational speed data points. Multidimensional correction vectors are also possible, individual dimensions being associated with the individual input variables. In the exemplary embodiment an additive correction value is also illustrated, multiplicative correction factors or polynomial formulations also being possible.

For a turbodiesel engine the correction term may be adapted when a setpoint torque close to dynamic maximum torque trqDynMax has been specified over a predetermined time period, so that a high injection quantity and high energy in the exhaust gas are present. In that case a further increase in the turbo system rotational speed or the charge pressure, and thus of the charge, is not expected. Alternatively, a correction term may be adapted when a charge pressure control system limits the charge pressure, and thus, the charge.

If necessary, the adaptation of the steady-state maximum torque and/or the correction term adaptation may be blocked for given operating states of the internal combustion engine to avoid faulty adaptation. This is possible, for example, when the rotational speed of the internal combustion engine changes substantially.

1-14. (canceled)

15. A method for operating an internal combustion engine, comprising:
ascertaining a steady-state maximum output torque and a dynamic maximum torque; and
adapting the ascertained steady-state maximum output torque in such a way that the adapted steady-state maximum output torque is equal to or greater than the ascertained dynamic maximum torque, wherein the adapted steady-state maximum output torque is ascertained as steady-state maximum torque.

16. The method as recited in claim 15, wherein at least one of the steady-state maximum torque and the dynamic maximum torque is ascertained using a model based on at least one of a variable and a characteristic curve.

17. The method as recited in claim 16, wherein for ascertaining the steady-state maximum torque, at least one of the following variables is used:
the rotational speed of the internal combustion engine;
a maximum charge in at least one combustion chamber of the internal combustion engine;
the smallest possible ignition angle of an ignition device of the internal combustion engine;
a fuel quantity;
a maximum possible injection quantity;
a fuel distribution in at least one combustion chamber of the internal combustion engine;
a fuel quality; and
an air/fuel ratio.

18. The method as recited in claim 16, wherein for ascertaining the dynamic maximum torque, at least one of the following variables is used:
the rotational speed of the internal combustion engine;
an instantaneous charge in at least one combustion chamber of the internal combustion engine;
the smallest possible ignition angle of an ignition device of the internal combustion engine;
a fuel quantity;
a maximum possible injection quantity;
a fuel distribution in at least one combustion chamber of the internal combustion engine;
a fuel quality; and
an air/fuel ratio.

19. The method as recited in claim 16, wherein a characteristic curve is used in the model, the characteristic curve describing at least one of the steady-state maximum torque and the dynamic maximum torque based on the rotational speed of the internal combustion engine.

20. The method as recited in claim 16, wherein for the adaptation of the ascertained steady-state maximum output torque, at least one correction term is applied to the steady-state maximum output torque to obtain the resulting steady-state maximum torque.

21. The method as recited in claim 20, wherein the correction term is adapted by a correction term adaptation in such a way that the resulting steady-state maximum torque approaches the dynamic maximum torque.

22. The method as recited in claim 21, wherein the correction term adaptation is carried out when operation of the internal combustion engine at maximum charge in the combustion chamber is detected.

23. The method as recited in claim 22, wherein the operation of the internal combustion engine at maximum charge is detected by the position of a throttle valve of the internal combustion engine.

24. The method as recited in claim 23, wherein a delay time is awaited for detecting the operation of the internal combustion engine at maximum charge.

25. The method as recited in claim 21, wherein the correction term is adapted when the ascertained resulting steady-state maximum torque is less than the ascertained dynamic maximum torque.

26. The method as recited in claim 25, wherein the internal combustion engine is part of a hybrid drive device.

27. A control system for an internal combustion engine, comprising:
means for ascertaining a steady-state maximum output torque and a dynamic maximum torque; and
an adaptation unit configured to adapt the ascertained steady-state maximum output torque in such a way that the adapted steady-state maximum output torque is equal to or greater than the ascertained dynamic maximum torque, wherein the adapted steady-state maximum output torque is ascertained as steady-state maximum torque.

28. A control system for a hybrid drive device of a motor vehicle having an internal combustion engine and an electric machine, comprising:
means for ascertaining a steady-state maximum output torque and a dynamic maximum torque; and
an adaptation unit configured to adapt the ascertained steady-state maximum output torque in such a way that the adapted steady-state maximum output torque is equal to or greater than the ascertained dynamic maximum torque, wherein the adapted steady-state maximum output torque is ascertained as steady-state maximum torque.
